(19) United States
(12) Patent Application Publication
(10) Pub. No.: US 2015/0339551 A1
(43) Pub. Date: Nov. 26, 2015

(54) IMAGE PROCESSING APPARATUS, IMAGE FORMING APPARATUS, AND NON-TRANSITORY COMPUTER READABLE MEDIUM

(71) Applicant: FUJI XEROX CO., LTD., Tokyo (JP)

(72) Inventors: Kosuke MARUYAMA, Kanagawa (JP); Makoto SASAKI, Kanagawa (JP)

(21) Appl. No.: 14/553,397

(22) Filed: Nov. 25, 2014

(30) Foreign Application Priority Data
May 26, 2014 (JP) 2014-108503

(51) Int. Cl. G06K 15/02

(52) U.S. Cl. CPC G06K 15/1848

(57) ABSTRACT

Provided is an image processing apparatus including a reception unit that receives designation of a foreground portion included in a foreground region of an image displayed on a display screen, and a region forming unit that forms a foreground candidate region including the foreground portion, wherein the reception unit receives designation of an addition to the image after the foreground candidate region is formed, and the region forming unit sets whether the designation of the addition is used to designate the foreground region or a background region of the image excluding the foreground region according to whether the designation of the addition is present outside or inside the foreground candidate region, and re-forms the foreground candidate region according to the foreground portion and the designation of the addition.

### CROSS-REFERENCE TO RELATED APPLICATIONS

This application is based on and claims priority under 35 USC 119 from Japanese Patent Application No. 2014-108503 filed May 26, 2014.

### BACKGROUND

### Technical Field

The present invention relates to an image processing apparatus, an image forming apparatus, and a non-transitory computer readable medium.

### SUMMARY

According to an aspect of the invention, there is provided an image processing apparatus including:

a reception unit that receives designation of a foreground portion included in a foreground region of an image displayed on a display screen; and

a region forming unit that forms a foreground candidate region including the foreground portion,

wherein the reception unit receives designation of an addition to the image after the foreground candidate region is formed, and

the region forming unit sets whether the designation of the addition is used to designate the foreground region or a background region of the image excluding the foreground region according to whether the designation of the addition is present outside or inside the foreground candidate region, and re-forms the foreground candidate region according to the foreground portion and the designation of the addition.

### BRIEF DESCRIPTION OF THE DRAWINGS

Exemplary embodiments of the present invention will be described in detail based on the following figures, wherein:

FIG. 1 is a block diagram illustrating an example of a configuration of an image processing apparatus and an image forming apparatus according to an exemplary embodiment of the invention (hereinafter, referred to as an exemplary embodiment);

FIGS. 2A to 2C are schematic diagrams illustrating states where a foreground candidate region is extracted from an image by an image processing apparatus and an image forming apparatus, in which FIG. 2A is a diagram illustrating an acquired image, FIG. 2B is a diagram illustrating a state where a foreground seed and a background seed are received, and FIG. 2C is a diagram illustrating a state where the foreground candidate region is formed;

FIGS. 3A to 3C are schematic diagrams illustrating states where a foreground candidate region is set to be larger than a foreground region that a user desires to extract and a part of a boundary line that defines the foreground candidate region is protruded into a background region, in which FIG. 3A is a schematic diagram illustrating a state where the foreground candidate region is displayed, FIG. 3B is a schematic diagram illustrating a state where an additional seed is received, and FIG. 3C is a schematic diagram illustrating the additional seed, and the previously received foreground seed and background seed;

FIGS. 4A to 4C are schematic diagrams illustrating states where a foreground candidate region is set to be smaller than a foreground region that a user desires to extract and a part of a boundary line that defines the foreground candidate region is protruded into a foreground region, in which FIG. 4A is a schematic diagram illustrating a state where the foreground candidate region is displayed, FIG. 4B is a schematic diagram illustrating a state where an additional seed is received, and FIG. 4C, is a schematic diagram illustrating the additional seed, and the received foreground seed and background seed;

FIG. 5A is a schematic diagram illustrating an example in which a start point of an additional seed indicated by a line is formed outside a foreground candidate region and an end point thereof is formed inside the foreground candidate region, and FIG. 5B is a schematic diagram illustrating an example in which the start point of the additional seed is formed inside the foreground candidate region and the end point thereof is formed outside the foreground candidate region;

FIG. 6 is a table that shows whether a control unit sets an additional seed as a foreground seed or a background seed in association with a position relation between a start point and an end point of a line received as the additional seed and the inside and outside of a foreground candidate region;

FIG. 7 is a flowchart illustrating an operation of an image processing apparatus and an image forming apparatus;

FIGS. 8A and 8B are schematic diagrams illustrating a state where an additional seed is received by designation of two points through a manipulation unit; and

FIG. 9 is a diagram illustrating an example of a hardware configuration that realizes functions of an image processing apparatus by a computer in which a program is read.

### DETAILED DESCRIPTION

Hereinafter, exemplary embodiments of the invention will be described with reference to the accompanying drawings.

<Configuration of Image Processing Apparatus and Image Forming Apparatus>

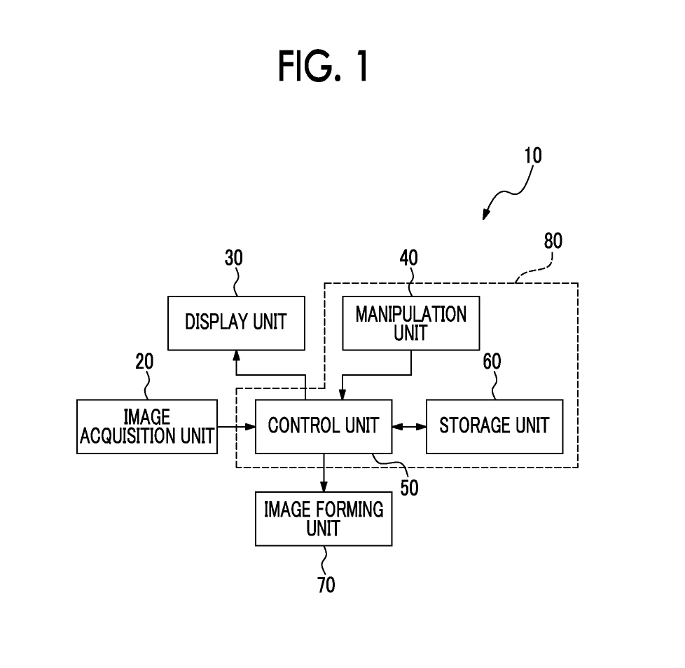

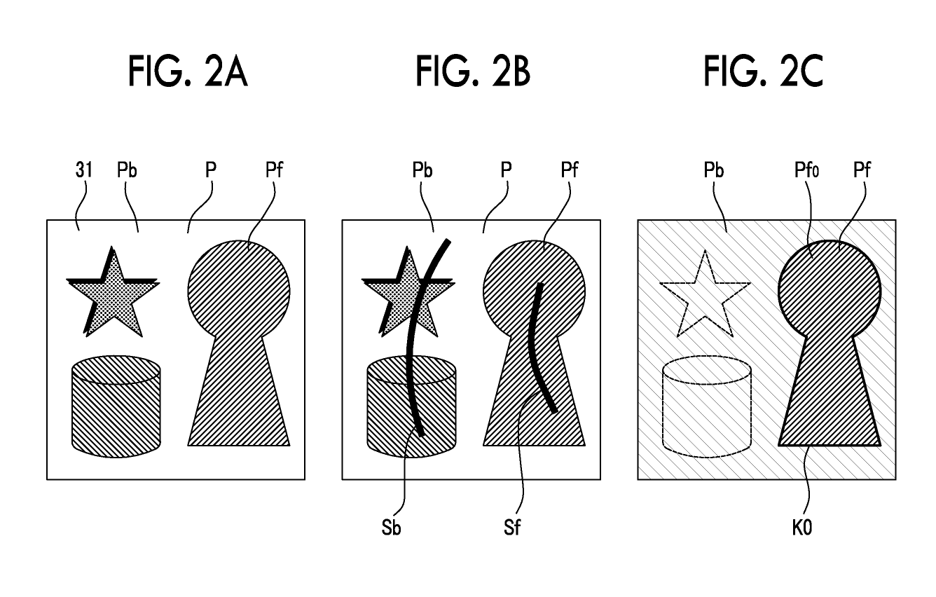

FIG. 1 is a block diagram illustrating an example of a configuration of an image processing apparatus 80 and an image forming apparatus 10 according to an exemplary embodiment of the invention. FIGS. 2A to 2C are schematic diagrams illustrating states where a foreground candidate region Pf0 is extracted from an image P by the image processing apparatus 80 and the image forming apparatus 10.

The image forming apparatus 10 shown in FIG. 1 includes an image acquisition unit 20 (image acquisition unit), a display unit 30 (image display unit), a manipulation unit 40 (reception unit), a control unit 50 (region forming unit), a storage unit 60, and an image forming unit 70 (image forming unit). Here, the control unit 50, the manipulation unit 40 and the storage unit 60 forms the image processing apparatus 80 that is an exemplary embodiment of the image processing apparatus according to the invention.

The image acquisition unit 20 acquires the image P shown in FIG. 2A, for example.

The display unit 30 includes a display screen 31 (see FIG. 2A) on which the acquired image P is displayed.

The manipulation unit 40 is, for example, a touch panel that is formed integrally with the display screen 31 of the display unit 30 and transmits the image P displayed on the display screen 31, which may receive designation of a part of the image P by a contact manipulation using a finger, a stylus pen or the like. The manipulation unit 40 receives designation of a foreground seed Sf (foreground portion) included in a foreground region Pf (see FIG. 2B) that a user desires to extract in the image P displayed on the display screen 31 and designation of a background seed Sb included in a background region Pb that is a portion of the image P excluding the foreground region Pf. In the first exemplary embodiment, both the foreground seed Sf and the background seed Sb are designated by lines as shown in FIG. 2B, and the invention is not limited to the designation by the lines. For example, the foreground seed Sf and the background seed Sb may be designated by points.

When designating the foreground seed Sf, the user presses a “Fore” button (not shown) displayed, on the display screen 31, and then traces a portion inside a range that the user desires to extract as the foreground region Pf using a finger, a stylus pen or the like. Thus, the overwritten portion is set as the foreground seed Sf. The number of the designated foreground seed Sf is not only one as shown in FIG. 2B, but may also foe two or more.

When designating the background, seed Sb, the user presses a “Back” button (not shown) displayed on the display screen 31, and then traces a portion outside the range that the user desires to extract as the foreground region Pf using a finger, a stylus pen or the like. Thus, the overwritten portion is set as the background seed Sb. The number of the designated background seed Sb is not only one, but may also be two or more.

Only the foreground seed Sf may be designated, and the background seed Sb may not be designated.

On the display screen 31, a “Cut” button (not shown) is displayed, in addition to the “Fore” button and the “Back” button. Thus, after the designation of each of the foreground seed. Sf and the background seed Sb or the designation of only the foreground seed Sf is completed, by pressing the “Cut” button, a formation process of the foreground candidate region Pf0 in the control unit 50 to be described later is executed.

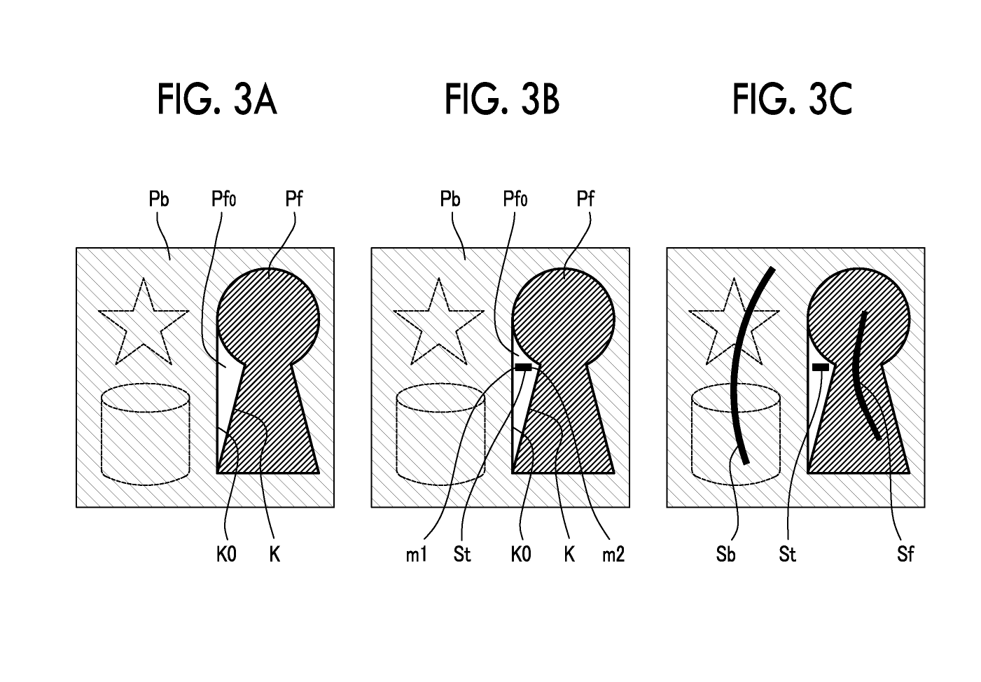

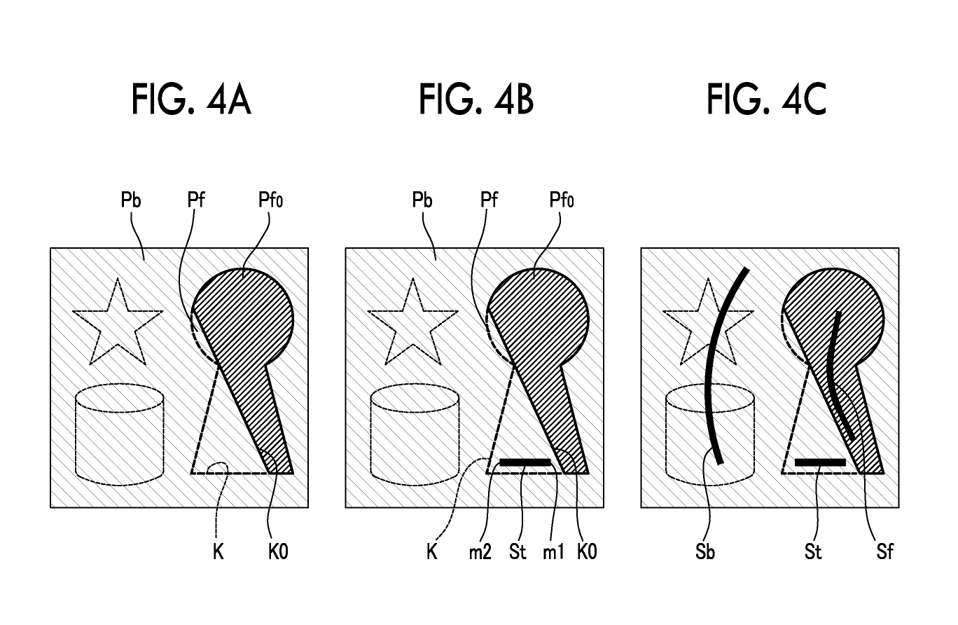

FIGS. 3A to 3C and FIGS. 4A to 4C are schematic diagrams illustrating states where the foreground candidate region Pf0 (see FIG. 2C) is not formed according to the user's desire. Specifically, FIGS. 3A to 3C are schematic diagrams illustrating states where the foreground candidate region Pf0 is set to be larger than the foreground region Pf that the user desires to extract and a part of a boundary line K0 that defines the foreground candidate region Pf0 is protruded into the background region Pb. Meanwhile, FIGS. 4A to 4C are schematic diagrams illustrating states where the foreground candidate region Pf0 is set to be smaller than the foreground region Pf that the user desires to extract and a part of the boundary line K0 that defines the foreground candidate region Pf0 is protruded into the foreground region Pf.

The manipulation unit 40 (see FIG. 1) may receive an additional seed St (designation of addition) including two points m1 and m2 (see FIG. 3B and FIG. 4B) in the image P after the foreground candidate region Pf0 (see FIG. 3A and FIG. 4A) is formed. The additional seed St shown in FIG. 3B and FIG. 4B is designated with a line by the user, similar to the foreground seed Sf and the background seed Sb, in which the point m1 represents a start point of the line and the point m2 represents an end point of the line. When receiving the additional seed St, the manipulation of pressing the “Fore” button for specifying that the additional seed St is a foreground seed or the “Back” button for specifying that the additional seed St is a background seed is not performed before the additional seed St is received.

The control unit 50 controls respective operations of the image acquisition unit 20, the display unit 30, the manipulation unit 40, and the storage unit 60. Further, the control unit 50 forms the foreground candidate region Pf0 as a region that includes the foreground seed Sf (see FIG. 2B) received through the manipulation unit 40 and does not include the background seed Sb. The formed foreground candidate region Pf0 is stored in the storage unit 60, together with the foreground seed Sf and the background seed Sb, by the control unit 50, and is displayed on the display screen 31 (see FIG. 2C). When only the foreground seed Sf is designated and the background seed Sb is not designated, the control unit 50 forms the foreground candidate region Pf0 as a region that includes the foreground seed Sf received through the manipulation unit 40.

As a method for forming the foreground candidate region Pf0 by the foreground seed Sf and the background seed Sb, for example, a graph cut algorithm may be applied.

After the foreground candidate region Pf0 is formed, the control unit 50 (see FIG. 1) sets the additional seed St as a foreground seed for designating the foreground region Pf or a background seed for designating the background region Pb according to whether the additional seed St received through the manipulation unit 40 is formed outside the foreground candidate region Pf0 or inside the foreground candidate region Pf0. Specifically, when the additional seed St is formed outside the foreground candidate region Pf0, the control unit 50 sets the additional seed St as the foreground seed, and when the additional seed St is formed inside the foreground candidate region Pf0, the control unit 50 sets the additional seed St as the background seed.

That is, before the additional seed St is received, the manipulation (pressing of the “Fore” button) of specifying that the additional seed St is the foreground seed or the manipulation (pressing of the “Back” button) of specifying that the additional seed St is the background seed is not performed, but the control unit 50 sets whether to cause the additional seed St to function as the foreground seed or to cause the additional seed St to function as the background seed according to the position relation between the additional seed St and the foreground candidate region Pf0.

The control unit 50 stores the additional seed St set as the foreground seed or the background seed in the storage unit 60.

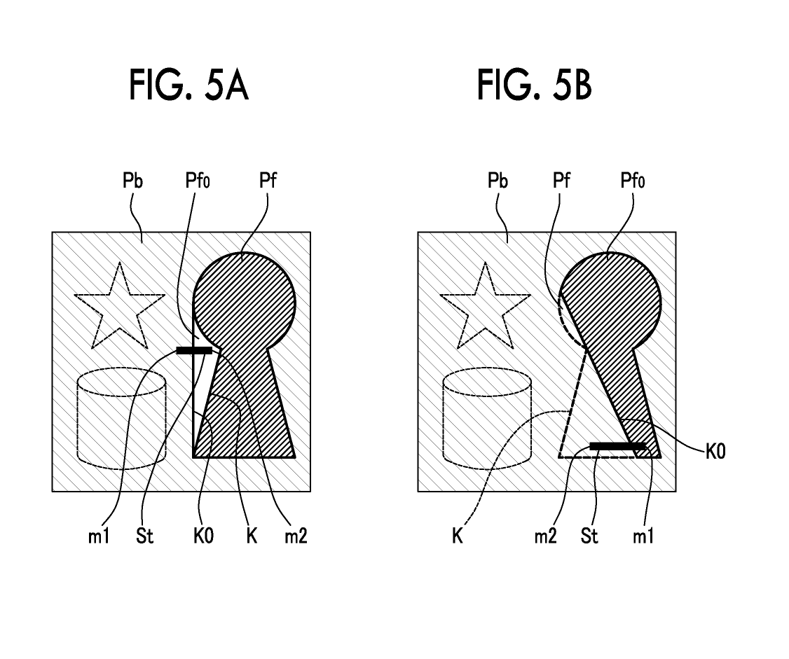

In the present exemplary embodiment, since the additional seed St is formed of the line, a part of the line may be formed inside the foreground candidate region Pf0, and the other part thereof may be formed outside the foreground candidate region Pf0. FIG. 5A is a schematic diagram illustrating an example in which one point m1 that is the start point of the additional seed St formed of the line is formed outside the foreground candidate region Pf0 and one point m2 that is the end point thereof is formed inside the foreground candidate region Pf0 and FIG. 5B is a schematic diagram illustrating an example in which the point m1 that is the start point of the additional seed St is formed inside the foreground candidate region Pf0 and the point m2 that is the end point thereof is formed outside the foreground candidate region Pf0.

In the examples shown in FIGS. 5A and 5B, the control unit 50 sets the additional seed St as the foreground seed or the background seed according to whether the point m2 of the line, received later in a time series manner, that is, the end point of the line is present outside or inside the foreground candidate region Pf0.

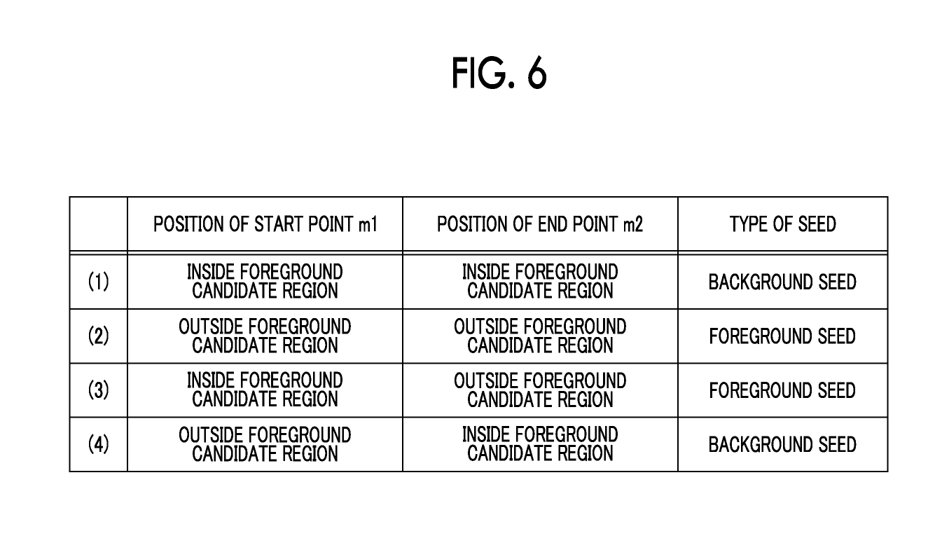

FIG. 6 is a table that shows whether the control unit 50 sets the additional seed St as the foreground seed or the background seed in association with the position relation between the start point (m1) and the end point (m2) of the line received as the additional seed St and the inside and outside of the foreground candidate region Pf0.

As shown in FIG. 6, the control unit 50 (1) sets the additional seed as the background seed when the start point (m1) of the line of the additional seed St is present inside the foreground candidate region Pf0 and the end point (m2) thereof is present inside the foreground candidate region Pf0, (2) sets the additional seed as the foreground seed when the start point (m1) of the line of the additional seed St is present outside the foreground candidate region Pf0 and the end point (m2) thereof is present outside the foreground candidate region Pf0, (3) sets the additional seed as the foreground seed when the start point (m1) of the line of the additional seed St is present inside the foreground candidate region Pf0 and the end point (m2) thereof is present outside the foreground candidate region Pf0, and (4) sets the additional seed as the background seed when the start point (m1) of the line of the additional seed St is present outside the foreground candidate region Pf0 and the end point (m2) thereof is present inside the foreground candidate region Pf0.

In this way, if the additional seed St is set as the foreground seed or the background seed, the control unit 50 (see FIG. 1) re-forms the foreground candidate region Pf0 by the foreground seed Sf and the background seed Sb stored in the storage unit 60 and the additional seed St set as the foreground seed or the background seed. The re-formed foreground candidate region Pf0 is stored in the storage unit 60 and is displayed on the display screen 31 by the control unit 50.

The image forming unit 70 forms an image using the foreground candidate region Pf0 formed by the control unit 50. Specifically, the image forming unit 70 may print only the formed foreground candidate region Pf0, or may generate a composite image by attaching the foreground candidate region Pf0 to a part of another image to print the composite image.

<Operation of Image Processing Apparatus and Image Forming Apparatus>

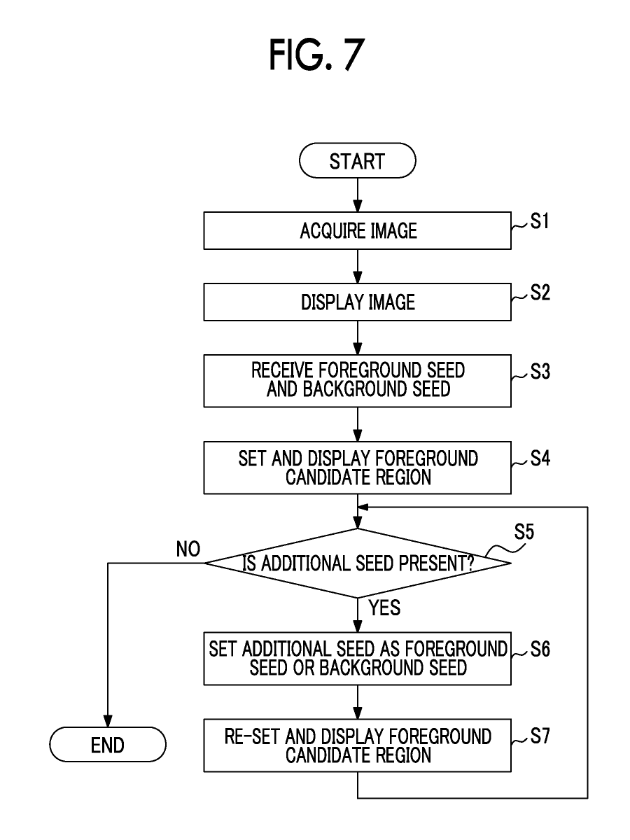

An operation of the image processing apparatus 80 and the image forming apparatus 10 as configured above will be described with reference to FIG. 7.

First, the image acquisition unit 20 (see FIG. 1) acquires the image P (S1). Then, the control unit 50 displays the image P acquired by the image acquisition unit 20 on the display screen 31 of the display unit 30, as shown in FIG. 2A (S2).

The image P displayed on the display screen 31 is visually recognized by a user. When the user designates the foreground region Pf that the user desires to extract from the image P, the user presses the “Fore” button displayed on the display screen 31, and then designates the foreground seed Sf inside a region that the user desires to extract as the foreground region Pf using a finger or a stylus pen (see FIG. 2B). Then, the manipulation unit 40 receives the foreground seed Sf (S3).

Similarly, when the user designates the background region Pb in the image P, the user presses the “Back” button displayed on the display screen 31, and then designates the background seed Sb inside a region that the user desires to extract as the background region Pb using a finger or a stylus pen (see FIG. 2B). Then, the manipulation unit 40 receives the background seed Sb (S3). Thereafter, the user presses the “Cut” button displayed on the display screen 31.

According to the pressing of the “Cut” button, the control unit 50 sets the foreground candidate region Pf0 as a region that includes the foreground seed Sf received through the manipulation unit 40 and does not include the background seed Sb according to the graph cut algorithm (S4). Here, the region of the image P displayed on the display screen 31 of the display unit 30, excluding the portion extracted as the foreground candidate region Pf0, is in a state of being covered by a mask having luminance of such a degree that the region is transmitted, as shown by a hatched portion in FIG. 2C.

The formed foreground candidate region Pf0 is stored in the storage unit 60, together with the received foreground seed Sf and background seed Sb.

Here, as shown in FIG. 2C, when the foreground candidate region Pf0 formed by the control unit 50 matches the foreground region Pf that the user desires to extract, the user does not want to correct the formed foreground candidate region Pf0. Accordingly, the additional seed St for correction of the foreground candidate region Pf0 is not received through the manipulation unit 40 (No in S5 in FIG. 7), and the process of extracting (or setting) the foreground candidate region Pf0 is finished.

On the other hand, as shown in FIG. 3A or FIG. 4A, when the foreground candidate region Pf0 formed by the control unit 50 does not match the foreground region Pf that the user desires to extract, the user inputs the additional seed St through the manipulation unit 40 in order to correct the foreground candidate region Pf0, and the manipulation unit 40 receives the additional seed St.

After the manipulation unit 40 receives the additional seed St (Yes in S5), the control unit 50 (see FIG. 1) sets whether the additional seed St is used to designate the foreground seed or the background seed based on the position relation between the start point (m1) and the end point (m2) of the additional seed St and the foreground candidate region Pf0, shown in FIG. 6 (S6).

Specifically, in the additional seed St shown in FIG. 3B, since the end point (m2) is present inside the foreground candidate region Pf0, the control unit 50 sets the additional seed St as the background seed. In the additional seed St shown in FIG. 4B, since the end point (m2) is present outside the foreground candidate region Pf0, the control unit 50 sets the additional seed St as the foreground seed.

Further, in the additional seed St shown in FIG. 5A, since the end point (m2) is present inside the foreground candidate region Pf0, the control unit 50 sets the additional seed St as the background seed. In the additional seed St shown in FIG. 5B, since the end point (m2) is present outside the foreground candidate region Pf0, the control unit 50 sets the additional seed St as the foreground seed.

The additional seed St set as the foreground seed or the background seed is stored in the storage unit 60.

The control unit 50 re-sets the foreground, candidate region Pf0 in the image P stored in the storage unit 60 based on the additional seed St stored in the storage unit 60 and the foreground seed Sf and the background seed Sb (see FIG. 3C and FIG. 4C) received through the manipulation unit 40 before the additional seed St is received, displays the re-set foreground candidate region Pf0 on the display screen 31 (S7), and stores the re-set foreground candidate region Pf0 in the storage unit 60.

When the re-set and displayed foreground candidate region Pf0 matches the foreground region Pf that the user desires to extract as shown in FIG. 2C, the additional seed St is not further received through the manipulation unit 40 (No in S5 in FIG. 7), and the process of extracting the foreground candidate region Pf0 is finished.

When the re-set and displayed foreground candidate region Pf0 does not match the foreground region Pf, the procedure from the process of further receiving the additional seed St (S5) to the process of re-setting and displaying the foreground candidate region Pf0 (S7) is repeated.

If the process of extracting the foreground candidate region Pf0 is finished, the control unit 50 outputs the foreground candidate region Pf0 stored in the storage unit 60 to the image forming unit 70, and then, the image forming unit 70 prints the foreground candidate region Pf0, or generates a composite image by attaching the foreground candidate region Pf0 to a part of another image to then print the composite image.

According to the image processing apparatus 80 and the image forming apparatus 10 of the present exemplary embodiment as configured above, when the formed foreground candidate region Pf0 that the user desires to extract as the foreground region Pf is corrected by the additional seed St, it is not necessary for the user to designate whether the additional seed St is used to designate the foreground region or the background region. That is, it is not necessary for the user to perform the operation of pressing the “Fore” button for specifying the intention of designating the foreground region or the “Back” button for specifying the intention of designating the background region before the additional seed St is input.

Further, in the image processing apparatus 80 and the image forming apparatus 10 of the present exemplary embodiment, the additional seed St is received as the line. Thus, the designated region is enlarged compared with a case where the additional seed St is designated by points.

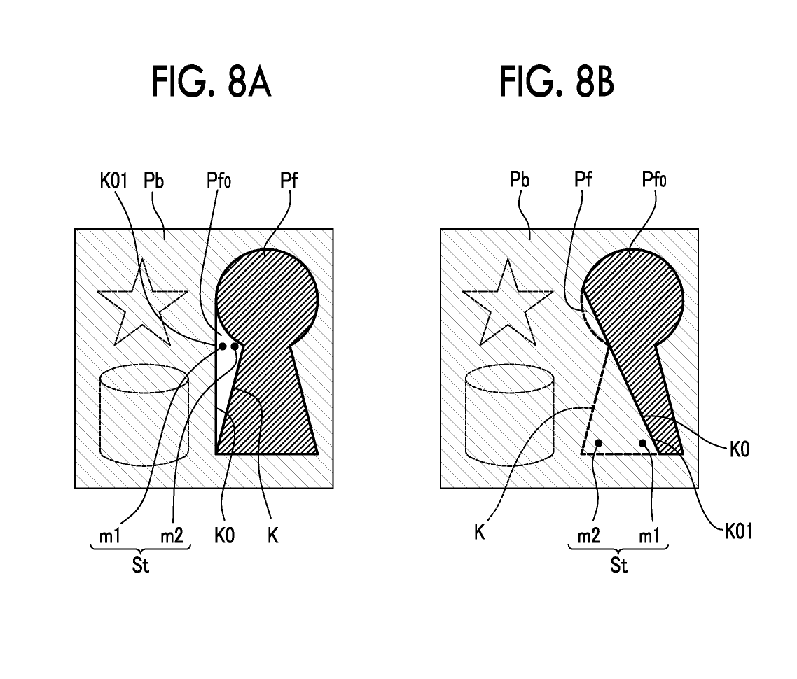

FIGS. 3A and 8B are schematic diagrams illustrating a state where the additional seed St is received by designation of two points m1 and m2 through the manipulation unit 40 (see FIG. 1).

In the image processing apparatus 80 and the image forming apparatus 10 of the above-described exemplary embodiment, the additional seed St is received by the line, but for example, as shown in FIGS. 8A and 8B, the manipulation unit 40 (see FIG. 1) may receive the additional seed St as two points m1 and m2. In this case, the control unit 50 sets whether the additional seed St is used to designate the foreground region or the background region according to whether the point m1 received later in a time series manner among two points m1 and m1 is present outside or inside the foreground candidate region Pf0.

Further, the control unit 50 may re-form the foreground candidate region Pf0 by primarily re-forming a portion K01 close to the point m1 received earlier in a time series manner among two points m1 and m2 received as the additional seed St, in the boundary line K0 that defines the foreground candidate region Pf0. According to the image processing apparatus 80 and the image forming apparatus 10 of this exemplary embodiment, the portion K01 of the boundary line K0 to be re-set is defined.

<Exemplary Embodiment of Program>

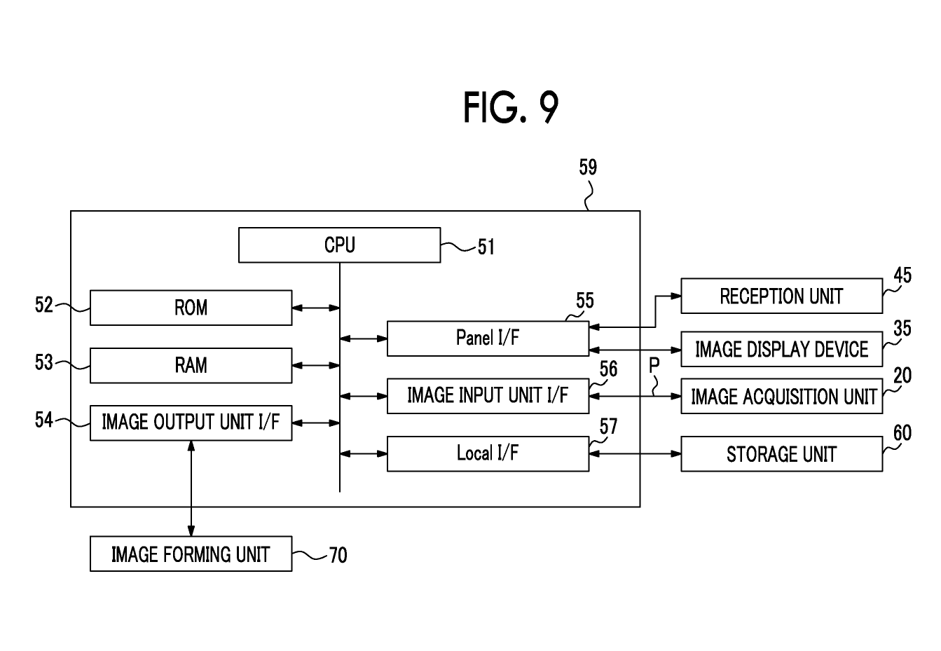

FIG. 9 is a diagram illustrating an example of a hardware configuration that realizes the above-described functions of the image processing apparatus 80 by a computer 59 in which a program is read.

The computer 59 includes a central processing unit (CPU) 51, a read only memory (ROM) 52, a random access memory (RAM) 53, an image output unit interface (image output unit I/F) 54, a panel interface (panel I/F) 55, an image input unit interface (image input unit I/F) 56, and a local interface (local I/F) 57.

The ROM 52 stores a program to be executed by the CPU 51. The CPU 51 reads the program stored in the ROM 52, executes the program by using the RAM 53 as a work area, and controls operations of the ROM 52, the RAM 53, the image output unit I/F 54, the panel I/F 55, the image input unit I/F 56, and the local I/F 57 according to the program.

The image output unit I/F 54 performs communication of data of the foreground candidate region Pf0, a control signal or the like with the image forming unit 70. The panel I/F 55 performs communication of information or a control signal with an image display device 35 and a reception unit 45. The image input unit I/F 56 performs communication of data of the image P or a control signal with the image acquisition unit 20. The local I/F 57 performs communication of data with the storage unit 60.

The image display device 35 displays an image on a display screen thereof. The reception unit 45 is a touch panel provided on the display screen of the image display device 35, for example. The reception unit 45 may employ a mouse, a touch pad or the like that is an input interface of a personal computer.

The CPU 51 in which the program is read displays the image P acquired, from the image acquisition unit 20 through the image input unit I/F 56 on the display screen of the image display device 35 through the panel I/F 55, and stores the image P in the storage unit 60 through the local I/F 57, Further, the CPU 51 receives the foreground seed Sf included in the foreground region Pf (see FIGS. 2A to 2C) and the background seed Sb included in the background region Pb, in the image P displayed on the display screen of the image display device 35, from the reception unit 45 through the panel I/F 55. The CPU 51 stores the received foreground seed Sf and background seed Sb in the storage unit 60 through the local I/F 57.

The CPU 51 forms the foreground candidate region Pf0 that includes the foreground seed Sf and does not include the background seed Sb, using the RAM 53 as a work area, with respect to the image P stored in the storage unit 60, based on the received foreground seed Sf and background seed Sb. The CPU 51 displays the formed foreground candidate region Pf0 on the display screen of the image display device 35 through the panel I/F 55, and stores the foreground candidate region Pf0 in the storage unit 60 through the local I/F 57.

After the foreground, candidate region Pf0 is formed on the display screen of the image display device 35, the CPU 51 receives the additional seed St through the reception unit 45. After the additional seed St is received, the CPU 51 stores the additional seed St in the storage unit 60, and sets whether the additional seed St is used to designate a foreground region or a background region according to whether the additional seed St is present outside or inside the foreground candidate region Pf0.

Further, the CPU 51 re-forms the foreground candidate region Pf0 that includes the foreground seed Sf, does not include the background seed Sb, and includes the additional seed St set in the foreground seed, or re-forms the foreground candidate region Pf0 that includes the foreground seed Sf, does not include the background seed Sb, and does not include the additional seed St set in the background seed, using the RAM 53 as a work area, with respect to the image P stored in the storage unit 60 based on the foreground seed Sf and the background seed Sb stored in the storage unit 60 and the additional seed St set as the foreground seed or the background seed.

According to the program as configured above, the computer 59 may function as the control unit 50 in the image processing apparatus 30 shown in FIG. 1, the reception unit 45 may function as the manipulation unit 40 therein, and the image display device 35 may function as the display unit 30 therein.

Accordingly, the same effects as in the above-described image processing apparatus 80 may be obtained according to such a program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a reception unit that receives designation of a foreground portion included in a foreground region of an image displayed on a display screen; and
a region forming unit that forms a foreground candidate region including the foreground portion,
wherein the reception unit receives designation of an addition to the image after the foreground candidate region is formed, and
the region forming unit sets whether the designation of the addition is used to designate the foreground region or a background region of the image excluding the foreground region according to whether the designation of the addition is present outside or inside the foreground candidate region, and re-forms the foreground candidate region according to the foreground portion and the designation of the addition.

2. The image processing apparatus according to claim 1,
wherein the reception unit receives the designation of the addition as a line, and
the region forming unit sets whether the designation of the addition is used to designate the foreground region or the background region according to whether an end point of the line is present outside or inside the foreground candidate region.

3. The image processing apparatus according to claim 1, wherein
the reception unit receives the designation of the addition as two points, and
the region forming unit sets whether the designation of the addition is used to designate the foreground region or the background region according to whether a point received later in a time series manner among the two points is present outside or inside the foreground candidate region, and re-forms the foreground candidate region by re-forming a portion of a boundary line that defines the foreground candidate region, close to a point received earlier in a time series manner among the two points.

4. An image forming apparatus comprising:
an image acquisition unit that acquires an image;
an image display unit that includes a display screen on which the acquired image is displayed;
a reception unit that receives designation of a foreground portion included in a foreground region of the image displayed on the display screen;
a region forming unit that forms a foreground candidate region including the foreground portion; and
an image forming unit that forms an image using the foreground candidate region,
wherein the reception unit receives designation of an addition to the image after the foreground candidate region is formed, and
the region forming unit sets whether the designation of the addition is used to designate the foreground region or a background region of the image excluding the foreground region according to whether the designation of the addition is present outside or inside the foreground candidate region, and re-forms the foreground candidate region according to the foreground portion and the designation of the addition.

5. A non-transitory computer readable medium that stores a program that causes a computer to execute functions, the functions comprising:
receiving designation of a foreground portion included in a foreground region of an image displayed on a display screen;
forming a foreground candidate region including the foreground portion;
receiving designation of an addition to the image after the foreground candidate region is formed; and
setting whether the designation of the addition is used to designate the foreground region or a background region of the image excluding the foreground region according to whether the designation of the addition is present outside or inside the foreground candidate region, and re-forming the foreground candidate region according to the foreground portion and the designation of the addition.
